(19) United States
(12) Patent Application Publication
(10) Pub. No.: US 2014/0084090 A1
(43) Pub. Date: Mar. 27, 2014

(54) METHOD AND DEVICE FOR CLEANING OF PAPER MACHINE CLOTHING WHICH IS TO BE RECYCLED

(71) Applicants: Torsten Kallweit, Ulm (DE); Matthias Schmitt, Munchen (DE)

(72) Inventors: Torsten Kallweit, Ulm (DE); Matthias Schmitt, Munchen (DE)

(21) Appl. No.: 13/625,501

(22) Filed: Sep. 24, 2012

(51) Int. Cl. B02C 23/08

(52) U.S. Cl. CPC B02C 23/08
USPC 241/24.29; 241/68

(57) ABSTRACT

A method for cleaning structural material which is to be recycled and is obtained from paper making-machine fabrics, in particular forming fabrics or press fabrics, includes the measures of a) comminution of a papermaking-machine fabric in order to obtain fabric-material particles and detaching particulate contaminating material from the papermaking-machine fabric and/or the fabric-material particles; b) separating the fabric-material particles from the particulate contaminating material; c) during or after execution of measure b), detaching contaminating material which adheres to the surface of the fabric-material particles obtained during measure b) by frictional cleaning; and d) during or after execution of measure c), separating the fabric-material particles from the contaminating material which is detached from the surface of the fabric-material particles.

### CROSS REFERENCE TO RELATED APPLICATIONS

This is a continuation of PCT application No. PCT/EP2011/054201, entitled “METHOD AND DEVICE FOR CLEANING OF PAPER MACHINE CLOTHING WHICH IS TO BE RECYCLED”, filed Mar. 21, 2011, which is incorporated herein by reference.

### BACKGROUND OF THE INVENTION

1. Field of the Invention

The current invention relates to a method with which paper machine clothing after the end of its service life can be recycled using its structural material to provide starting material, for example, for new paper machine clothing. The current invention relates in particular to a method with which paper machine clothing can be separated from contaminants adhering to same during the paper manufacturing process in order to be able to produce high quality starting material in the recycling process. The current invention moreover relates to a device to provide structural material from paper machine clothing which is to be recycled and with which, for example, a previously discussed method can be implemented.

2. Description of the Related Art

In order to avoid excessive contamination of the clothing during the operational life of paper machine clothing these are cleaned in the paper machine, also during ongoing paper production. Due to their influence upon the dewatering characteristics of the clothing on the one hand, and due to the creation of marking effects on the other hand such contaminations may affect the quality of the produced paper. Therefore, generally mechanically or respectively abrasively functioning procedures are used for cleaning of the paper machine clothing whereby contaminants are removed from the paper machine clothing by use of scrapers, brushes and high pressure water jets or also by use of dry ice.

After completion of the operational life cycle and when returning the structural material of paper machine clothing into the production cycle of new paper machine clothing it is necessary to remove the contaminants which are still present in and partially strongly adhere to the clothing. Basically, the procedures known from cleaning paper machine clothing directly in the paper machines can be utilized for this. Since they are generally conducted with the use of substances such as water or dry ice, they require however comparatively expensive cleaning procedures within the scope of recycling, resulting in a considerable cost factor.

What is needed in the art is a method and a device for cleaning paper machine clothing which is to be recycled with which structural material, essentially freed from contaminants, is obtained simply and cost effectively.

### SUMMARY OF THE INVENTION

The present invention provides a method for cleaning structural material which is to be recycled and which is obtained from paper machine clothing, in particular from forming fabrics, dryer fabrics, belts or press felts, including the following measures:
a) comminuting of paper machine clothing in order to obtain clothing material particles and thereby detaching of particulate contaminant material from the paper machine clothing and/or the clothing material particles;
b) separating of clothing material particles from the particulate contaminant material;
c) during or after implementation of measure b), detaching by use of friction cleaning of contaminant material adhering to the surface of the clothing material particles obtained under measure b); and
d) during or after implementation of measure c), separating of the clothing material particles from the contaminant material which is detached from the surface of the clothing material particles.

The method according to the present invention distinguishes itself first and foremost in that it occurs dry, in other words without addition of, for example water or dry ice. Removal or detachment of contaminant material from the clothing material particles or respectively the clothing per se, obtained in the first process step occurs substantially mechanically. In the process steps wherein larger contaminant particles are removed for the purpose of primary cleaning and wherein contaminants wetting or covering the surface of the clothing material particles are detached and removed for the purpose of final cleaning, the clothing or respectively the clothing material particles are moved against each other or respectively against surfaces of other bodies. The hereby occurring shearing forces or abrasive forces contribute to efficient cleaning of the clothing material particles. The subsequent separation of liquid on the one hand and cleaned clothing material particles on the other hand is therefore not necessary. The clothing material particles obtained in the cleaning process can consequently be fed directly into the recycling cycle. Drying or conditioning of the separated contaminants is not necessary.

If a cutting mill is used in measure a) in order to cut the paper machine clothing or respectively larger segments thereof into clothing material particles, detachment of coarser contaminating particles is facilitated, in particular through the action of the cutting knives.

Provision may for example be made that in the implementation of measure a), clothing material particles having an essentially predetermined particle size are produced, whereby the predetermined particle size is in a range of, for example, approximately 2 to 30 millimeters (mm), or 10 mm. It has been shown that, when comminuting paper machine clothing, for example by means of a cutting mill, the thus obtained clothing material particles are of a size—even over a plurality of particles—which does not deviate greatly from the predetermined particle size. This means that the size spread is relatively small. Nevertheless it has been shown that the contaminant material particles still remaining in the paper machine clothing emerge from this comminution process having a clearly smaller particle size. Based on the then existing clear size differentials on the one hand and the generally also existing mass- or respectively density-differentials on the other hand, a separation of the clothing material particles from the particulate contaminants can subsequently be accomplished efficiently.

Thereby it may be provided that measure b) includes screening and/or sorting in order to separate the clothing material particles from the particulate contaminant material. Regardless of which procedure is used to separate these two previously discussed particle fractions, the addressed differences in particle size or respectively mass and density come so clearly to bear that the particulate material obtained after this separation step contains practically only clothing material particles, however no longer any particulate contaminant material.

Measure c), in other words the friction cleaning procedure which is to be regarded as the final cleaning procedure can include movement of the clothing material particles against each other. The clothing material particles themselves therefore act as abrasive material and remove the contaminant material adhering to the surface of other clothing material particles. Since this process generally occurs in a closed volume wherein possibly structural components are present which cause the clothing material particles to move, these obviously also come into contact with the surfaces limiting the volume, or surfaces of the structural components causing the movement which equally contributes to removal of contaminants from the clothing material particle surface.

The contaminants adhering to the surface of the clothing material particles contain—amongst others—also contaminants which are referred to as “stickies” and which often have resinous or sticky characteristics and which are composed of materials which are contained in the pulp utilized in the paper manufacturing process and which accumulate on the surface of the paper machine clothing. In order to assist detachment of these partially sticky or aggressively adhering contaminants it may be necessary in individual cases that, when implementing measure c), the clothing material particles are brought into contact with extraction mediums. An extraction medium of this type can obviously be utilized depending on the contaminants present and represents a solvent which assists detachment of the clothing material particles. In this context it must be pointed out that the use of an extraction medium of this type occurs in such a manner that only an amount sufficient to cover or moisten the surfaces of the clothing material particles is added, that however no dispersion containing the clothing material particles is formed. In this respect, even when utilizing an extraction medium of this type, one can still refer to a basically dry implementation of the cleaning process. As a rule one can forgo the addition of an extraction medium.

Measure d) can also be implemented such that it includes screening and/or sorting for the purpose of separating the clothing material particles from the contaminant material detached therefrom. Here it is to be considered that the contaminants detached from the clothing material particle surface will have a clearly lesser size and thereby also mass than the clothing material particles themselves. They may have the consistency of powder- or oily dust and can therefore be separated efficiently from the clothing material particles through screening or sorting. During screening, as well as during sorting, the clothing material particles are moreover put into motion so that the detached contaminants which, however, possible again attach to the surface can be separated efficiently from the particles of the clothing material.

As previously described, the contaminant material adhering to the surface of the clothing material particles may have resinous or sticky characteristics. In order to avoid that excessive heating of the clothing material particles due to the energy input during the friction cleaning step leads to smearing of these contaminants on their surface it is suggested that, when implementing measure c) and/or measure d), the clothing material particles are kept in a predetermined temperature range, for example approximately 25 to 30° C.

In accordance with an additional aspect, the current invention relates to a method for recycling of the structural material of paper machine clothing, for example forming fabrics or press felts, including the following measures:
A) Implementation of a cleaning process according to the present invention, as described previously to obtain substantially cleaned clothing material particles; and
B) Pelletization of the clothing material particles gained in measure A) in order to obtain pellets.

Since the clothing material particles obtained in the cleaning procedure are already largely separated from contaminants and also no separation of the liquids or similar substances used in the cleaning process is necessary, the procedure for pelletizing, and therefore for obtaining pellets suitable, for example, for the composition of new paper machine clothing can be initiated without additional process steps, particularly when the clothing material particles or the paper machine clothing comminuted to obtain the particles were/was composed from one single base material.

If the paper machine clothing used as starting material is composed, for example with threads containing different base materials, it is moreover suggested that after implementation of measure A) and prior to implementation of measure B), the substantially cleaned clothing material particles are separated in particle fractions of different base materials. This ensures that the pellets received after the pelletization process are not composed of mixed materials, but of base materials used also in different threads.

It may be provided that measure B) includes an extrusion process, for example with filtration of the extrusion material.

The present invention further provides a device to provide structural material from paper machine clothing which is to be recycled, for example for implementation of the inventive method, including a comminution section to comminute paper machine clothing, a friction cleaning section to detach contaminants from clothing material particles, a separation section to separate the clothing material particles from contaminant material detached from them in the comminution section and/or the friction cleaning section.

In order to achieve an as complete as possible disintegration of the paper machine clothing that is to be recycled in the comminution section, for example a substantially complete break-up of a fabric structure, but on the other hand to also achieve a defined comminution of the disintegrated clothing material it is moreover suggested that the comminution section includes a pre-comminution unit and a subsequent primary comminution unit. The pre-comminution unit may include a single-shaft comminutor or a cutting mill.

In order to already presort the material which was reduced in size in the comminution section and which contains clothing particle material as well as particulate or dust-like contaminant material prior to passing it along to the friction cleaning section, further provision may be made that between the comminution section and the friction cleaning section a pre-separation unit is provided to separate clothing material particles from contaminant material detached from them in the comminution section. A gravity separator may be utilized for this purpose.

According to a further embodiment of the present invention, the friction cleaning sections provides the separation section. This means a merging of functions, making the configuration of the device cheaper and simpler.

It may, for example, be provided that the friction cleaning section includes a screen unit, such as a tumbler screen with at least one, for example at least two screen tiers. It has been shown that using a tumbler screen unit of this type, for example when a brush arrangement is allocated to at least one screen tier has, on the one hand, led to a very good friction cleaning result, and on the other hand the separation of contaminants detached from the clothing material particles contributes to efficient cleaning.

Moreover, it may be provided that the separation section following the friction cleaning section includes an after-cleaning unit. This achieves a very clean recycling material which can be fed to the further recycling process, for example to pelletizing, without extensive processing. The after-cleaning unit may, for example, include a dry-cleaning cylinder.

### BRIEF DESCRIPTION OF THE DRAWINGS

The above-mentioned and other features and advantages of this invention, and the manner of attaining them, will become more apparent and the invention will be better understood by reference to the following description of an embodiment of the invention taken in conjunction with the accompanying drawings, wherein:

FIG. 1 is a basic illustration of process steps occurring in a cleaning process, or respectively during a recycling process for paper machine clothing according to the present invention; and

FIG. 2 is an illustration of an inventive device with which the method of the present invention illustrated in FIG. 1 can be implemented.

Corresponding reference characters indicate corresponding parts throughout the several views. The exemplification set out herein illustrates one embodiment of the invention and such exemplification is not to be construed as limiting the scope of the invention in any manner.

### DETAILED DESCRIPTION OF THE INVENTION

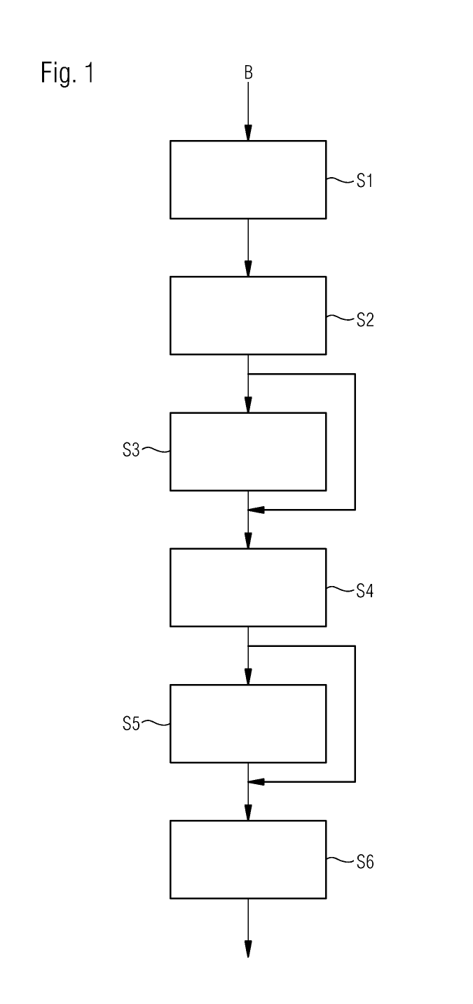

Referring now to the drawings, and more particularly to FIG. 1, there is shown a paper machine clothing B which is to be recycled after removal from a paper machine is provided at the beginning of the procedure illustrated by various process steps S. Depending on the specific purpose of service in the paper machine, in other words as forming fabric, dryer fabric, belt or press felt, clothing B can be a woven fabric or a composite of a woven fabric or another carrying structure including a nonwoven or felt type material. So-called spiral screens are also utilized as clothing in paper machines and can be recycled in the manner described below.

The structural material of paper machine clothing B of this type is generally polymeric material, for example PPS (polyphenylene sulfide) in the case of a spiral screen or PA (polyamide) in the case of a press felt.

Paper machine clothing P intended for comminution in process step S1 can first be cut into individual pieces, in order to then reduce them consecutively in size in a cutting mill or simultaneously in several cutting mills. The device used for comminution, for example the cutting mill, can be adjusted for this purpose to a predetermined desired particle size which may, for example, be in the range of between approximately 2 and 10 mm. After appropriate adjustment cutting mills deliver a cut up particle material which has only a comparatively small mean deviation from the predetermined particle size.

When implementing step S1, in other words during comminution of paper machine clothing B, not only its thread- or nonwoven- or spiral-like components are reduced in size, but larger or respectively particulate contaminants still present in the paper machine clothing are initially detached. This occurs based on the fact that due to the action of the cutting knives upon paper machine clothing B, and also due to the movement of individual components of paper machine clothing B, counter forces occur which detach the only comparatively weakly adhering particulate contaminants. Since the particulate contaminants have a comparatively porous, crumbly consistency they are not only detached in a comminution chamber from the clothing material particles or respectively from clothing B, but are additionally reduced in size due to this mechanical action of the cutting knives and the impact-, friction- and shearing-load. The result is that clothing material particles are contained in the thus obtained particle material which essentially have a particle size within the predetermined size range, as well as also particulate contaminant material whose particle size is generally smaller than the particle size of the clothing material particles.

In subsequent step 2 of the method these two particle fractions—the clothing material particles on the one hand and the particulate contaminants which are present at least partially in dust-like configuration on the other hand—are separated from each other. Various procedures may be used for this purpose. It is possible to separate the fraction utilizing screens, for example a tumbler screen with brushes whereby the screen opening size is selected so that the clothing material particles are retained, whereby the particulate contaminants fall through the screen. By utilizing the different particle sizes and also the different particle masses resulting therefrom on the one hand, on the other hand also by utilizing the various densities of the structural material of the clothing material particles on the one hand and the particulate contaminants on the other hand these two particle fractions can be separated from each other at a very high level of reliability also through screening, for example through air separation.

The clothing material particles contained following separation step 2 generally still have contaminants adhering to their surface. These form a film-like coating of dirt or comparatively strongly adhering deposits. These contaminant materials consist generally of resinous or sticky substances which in paper manufacturing are contained in the pulp which is used in the production of paper and which is in contact with the clothing and which accumulate on clothing B over its serviceable life. Since these comparatively strongly adhering contaminant materials cannot, or respectively can only partially be removed in first process step S1, that is during comminution and the thereby occurring effect upon the surface of the clothing material particles, the clothing material particles already separated from the coarser particulate contaminants are subjected to a friction cleaning process in process step S3. The strong movement of the clothing material particles against each other and also against the surfaces of one chamber containing the clothing particles, or of one agitator moving in the chamber cause an abrasive effect, detaching the initially still adhering contaminant material. This effect can be aided in that additional abrasive objects, for example abrasive balls or similar objects can be added. Since these comparatively strongly adhering contaminants have resinous or sticky characteristics it is moreover possible to admix an extraction agent. This extraction medium constitutes a solvent for these adhering contaminant materials and thereby aids detachment from the surface of the clothing material particles. The extraction medium is hereby added only to the extent that no dispersion of the clothing material particles occurs in the liquid, but that a moistening of the surface of the particles occurs and that the process is conducted still essentially dry.

Friction cleaning step S3 can occur by utilizing various known devices which, due to energy input and movement of particles against each other, are used to create an abrasive action on the surface of the particles. Such devices are used for example in the food industry in order to rid grains, grains of rice, peas, lentils, dried beans, pepper, millet and similar products of their husks. They are known as so-called brushing-, husking-, refining-, grinding- or polishing machines. Depending on the extent of the contamination or on the contaminants adhering to the surface of the clothing material particles, several of these devices may be used in combination.

Other machines, for example washing cylinders, rotating tumble screens, cyclone screeners, vibration screws or other screw systems can be used on the basis of two worm- or blade rows which are located opposite each other and engage with each other.

It is also possible to perform the friction cleaning between two surfaces moving against each other and which stress the clothing material particles and which in the final analysis work on the principle of a so-called fertilizer as used in the pulping of the cellulose fibers in paper production.

In as far as process step 3, in other words friction cleaning, occurs in a machine suitable or provided for this process, or respectively in a chamber which is substantially enclosed, one can assume that the contaminant material detached from the surface of the clothing material particles is present in a dust-like configuration and due to electrostatic effect will again accumulate on the surfaces of the clothing material particles, will however no longer develop a stronger adhesion effect. In order to achieve a separation of this contaminant material from the clothing material particles, a separation of the by then essentially completely cleaned clothing material particles from these contaminant materials is achieved subsequently in separation step S4, again by use of a sorting or screening process. During this separation process—especially if it is implemented with a separator, basically however also by use of a screen—an additional mechanical action on the surface of the clothing material particles is obtained, so that not only already detached contaminant materials are separated, but also additional surface cleaning is achieved. Depending on the extent to which the paper machine clothing used for recycling was contaminated it is basically also possible to use separation step S4 in which also an abrasive effect is achieved on the clothing material particles, as a sole friction cleaning step with simultaneous separation of the clothing material particles from the detached contaminants. This means that step 4 then does not only provide the separation step, but at the same time also the friction cleaning step, so step 3 shown in FIG. 1, serving exclusively as friction cleaning step, is not required.

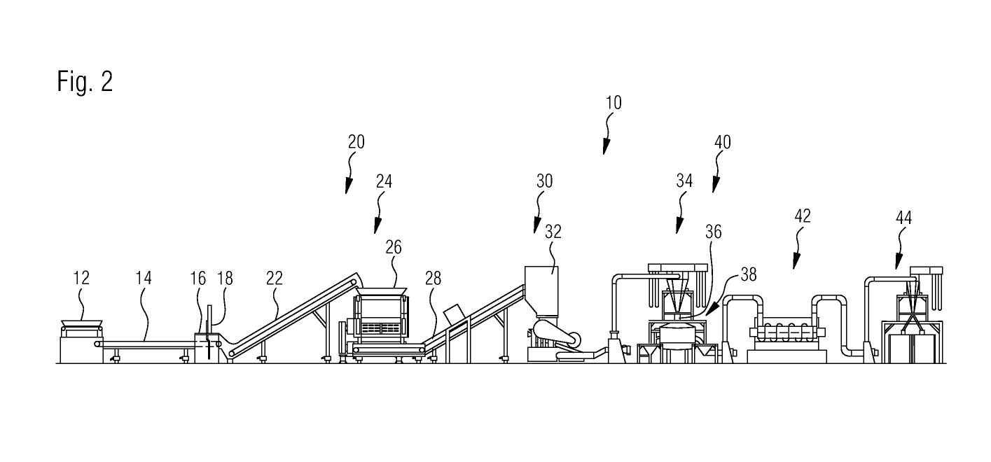

It can also be seen from the previous illustration that a separate separation step does not necessarily have to be provided following comminution performed in process step S1. In fact, the particulate and partially also dust-like material stemming from comminution can be achieved directly from the friction cleaning process and thereby the separation of the clothing material particles from the contaminant materials on the one hand or respectively from contaminant particles on the other hand. This is explained in detail below with reference to FIG. 2. Based on the fact that during the comminution process the contaminant particles detached from the clothing material particles are partially in powder- or dust-like configuration, a separation of this already detached contaminant material may be achieved prior to the friction cleaning process. The reason for this is that the efficiency of the friction cleaning process can be improved when less contaminant material, in particular dust-like contaminant material, is included in this process and thereby essentially only clothing material particles with potentially contaminants adhering thereto utilize energy for friction cleaning.

As already discussed, separation step S4 can be performed, for example, in a separator, with or without an upstream friction cleaning step. For this purpose a so-called zigzag-separator, air separator or cross-flow separator, or plan sifter can be used. The clothing material particles may also be separated from the detached contaminants in a cyclone screener whereby due to the turbulence the particles impact against each other and also against the chamber walls containing the particles and whereby on the one hand detachment of the contaminants is aided and on the other hand output of undersized particles provided essentially by the contaminant material, and coarse material provided by essentially the cleaned clothing material particles is achieved.

In the process steps serving the friction cleaning, for example process step S3 and possibly also process step S4, heating of the particle material is caused due to the comparatively strong movement of the particle material and associated intensive energy input, and in general also through the thereby occurring friction action. Especially if the contaminants still adhering to the particle material, have resinous characteristics it can lead to smudging of these contaminants across the surface of the clothing material particles, since the viscosity of the adhering contaminant material decreases due to the temperature increase. To counter this, when performing process steps S3 and/or S4 steps may be taken to ensure that excessive temperature increases do not occur. A temperature level in the range of between approximately 25 to 30° C. may be maintained, for example through blowing in of accordingly tempered or cooled air.

After process step 4, including the concluding separation of clothing material particles from contaminant material, the clothing material particles are generally available in a form which can be used directly for pelletization. In particular, there is no longer the danger that sub-standard pellets are received due to contaminations in the pelletizing process. There is however the possibility that the initially made available paper machine clothing B was not composed of one base material, but contained, for example, threads or filaments of various base materials. Mixing of such base materials during the pelletization process is generally not desirable. Rather, each base material or each particle fraction of a certain base material should be subjected to the pelletization process separately to again accordingly obtain pellets from this base material.

In so far as this is necessary a separation of the fraction of the clothing material particles consisting of different base materials can be performed in additional separation step S5 after completion of the cleaning procedure with separation step 4. This separation may occur in different ways, for example again by utilizing the differences in density of the different base materials. Here, centrifugation aided by the separation of density, or screening may be undertaken.

Screening, aided also by partial agglomeration, can be used to separate the fraction of different base materials from each other, in order to then feed them accordingly separated from each other to the pelletization process.

This pelletization process occurs as last process step S6. Here it can be ensured for example in an extrusion process by using a high vacuum filtration or melt filtration that the last contaminants still adhering to the surface of the clothing material particles are removed. Obviously, a combination of various extrusion filtration techniques can also be utilized. For example, so-called filter cascades or self-cleaning melt filters with automatic scrapers can be used.

At the end of the pelletization process, pellets of the desired pellet size and containing ultra-pure structural material are obtained which can be supplied to the production process of paper machine clothing, in particular to the production process of threads which are utilized in the composition of paper machine clothing.

With the procedure according to the present invention it is possible to provide a very pure particulate starting material for a pelletization process in a simple, dry, however reliable manner, whereby this starting material is obtained from paper machine clothing which can no longer be used. The previously discussed devices which may be utilized in the various process steps are obviously to be understood merely as examples. Other devices, for example a shredder or a single- or multiple-shaft comminutor can also be used in process step S1. Also other types of separators which, based on density and/or mass differences ensure a division into streams of various fraction can be utilized.

Below, a device is described with reference to FIG. 2 and which is generally designated 10 and with which the previously described method for cleaning paper machine clothing which is to be recycled can be performed.

At the beginning of this device or respectively the cleaning process, feeding hopper 12 is located into which paper machine clothing precut into larger pieces is fed. The pieces can be part of a paper machine clothing or an entire paper machine clothing and are transported via belt 14 to guillotine 16. In this guillotine these paper machine clothing pieces are comminuted by cutting knives 18 provided therein. Guillotine 16 is part of a comminution section which is generally identified as 20.

The pieces of the paper machine clothing to be recycled delivered from guillotine 20 are fed via conveyor 22 into pre-comminution unit 24. In the illustrated example this is so-called single shaft comminutor 26. Cutting blocks are mounted on the single shaft of this single shaft comminutor which, for example are provided with four cutting edges and can be turned according to wear. Frequent regrinding can therefore be avoided. In particular, it is possible to completely replace the cutting blocks, if necessary. The pieces delivered via conveyor 22 from the top are drawn through the rotating shaft of single shaft comminutor 26 into a comminution chamber. Moreover, the material to be reduced in size can be pushed into the cutting chamber utilizing a movable pusher. Should the shaft of single shaft comminutor 26 jam, it can be moved in the opposite direction in order to clear it. In addition opening of a hatch on the cutting chamber provides access to same, so that the pieces blocking the shaft can be removed.

A screen is mounted underneath the shaft of single shaft comminutor 26. The material to be reduced in size falls through this screen onto additional conveyor 28. Those components which are not yet so small that they can fall through the screen are returned to the cutting chamber and are subjected to further comminution.

From pre-comminution unit 24, conveyor 28 transports the material—which for example, if the clothing that is to be recycled had a fabric structure, still maintains at least part of a fabric structure—to primary comminution unit 30. In the illustrated example this is in the embodiment of cutting mill 32. Pieces, delivered by conveyor 28 are fed into the cutting mill from the top. They fall downward into the cutting chamber of the cutting mill where the cutting shaft with knives provided on it is located.

In the cutting mill the components of a paper machine clothing supplied to it are reduced to a size in the range of approximately 1 centimeter (cm) to 3 cm. In order to ensure that only particles of this size or of this size range are delivered, a screen may also be provided in the lower section of the cutting mill, so that in fact only material accordingly reduced in size is delivered.

Cutting mill 32, or in other words primary shredding unit 30, represents the final part of the system of comminution section 20. From comminution section 20 the therein produced particles are transported in the direction of a friction cleaning section, generally identified as 34.

Here it must however be considered that during the comminution process contaminants contained in the paper machine clothing to be recycled are detached from it or respectively from the clothing material particles. At least some of these contaminant particles are very finely crushed or ground in the comminution process. Smaller particles can also be detached from the structural material of the paper machine clothing, so that the entire comminution process can lead to accrual of very fine particle material, provided essentially by contaminants. A separation of these very fine dust-like particles may be effectuated before feeding into friction cleaning section 34. For this purpose a gravity separator, for example a cyclone may be provided at the outlet of the cutting mill. With this the dust-like particles which are delivered from cutting mill 32 together with the particle material which is to be further processed can be extracted, so that already a pre-cleaning or pre-separation of the clothing particle material which is to be delivered to friction cleaning section 34 is achieved. It has been shown that this extraction of dust-like contamination is particularly advantageous since the efficiency of the subsequent friction cleaning process is clearly increased by it.

Various process steps can be performed simultaneously in friction cleaning section 34. To make this possible, friction cleaning section 34 can be equipped with screen unit 36 which, for example is in the form of tumble screen unit 38. At least one, for example several screen tiers having screen opening sizes decreasing from top to bottom are provided. The clothing material particles are placed on the top screen and are put into motion by brushes, such as so-called three-way brush rings with nylon bristles moving across the screen. The clothing material particles move hereby against each other on the screen. Due to the friction caused by this, contaminants still adhering to the surface of the clothing material particles are detached. The movement of the brushes on the screen also leads to increased passing of particles through the screen. This process can be repeated from the top to the bottom in several screen tiers, so that always a fraction of clothing material particles whose size does not permit passing through the openings of a respective screen, remains on each screen. To avoid clogging of the screen openings, balls consisting of a rubber material could for example be arranged under each screen tier. Due to the movement taking place these rubber balls are also set into motion and thereby bump from below against a respective screen tier. This causes the particles which are clogging the screen openings to break loose.

If, for example two screen tiers are used then the upper screen can have an opening size or respectively mesh width of approximately 2 mm, whereas the lower screen can have an opening size or respectively mesh width of approximately 0.6 mm. Those particles which move through the upper screen tier as well as through the lower screen tier are practically 100% generally dust-like contaminant particles detached from the clothing. A portion of approximately 94 weight % of the clothing material particles remain on the lower screen tier, in other words on the tier having the smaller mesh size. Approximately 2.7 weight % remain on the upper screen tier which means that approximately 1.8 weight % of the supplied starting material is discharged as contaminant material or waste material.

According to a further embodiment of the present invention, where three screen tiers are arranged on top of each other an additional screen tier having an opening or respectively mesh size of approximately 1.0 mm can be provided between the already previously discussed upper and lower screen tiers. Here we have a somewhat finer gradation of the particles retained on the individual screen tiers. It has been shown that with such an adjustment of the mesh sizes again approximately 2.7 weight % remain on the upper screen layer. These clothing material particles essentially have a length of at least approximately 2 cm. Clothing material particles having essentially a size of at least approximately 1 cm remain on the center screen tier which has a mesh width of approximately 1 mm. Their proportion is approximately 47 weight %. A proportion of approximately 47 weight % also remains on the bottom screen tier.

The previously described friction cleaning section not only serves to rub together the individual clothing material particles for the purpose of detaching contaminants, but the clothing material particles are also separated from the contaminants which are detached from them. This means that friction cleaning section 34 here also simultaneously embodies separation section 40. In this friction cleaning/separation section the particulate material—which can include clothing material particles as well as contaminants or respectively contaminant particles—discharged from comminution section 20 can be subjected to a separation process as well as to a friction cleaning process. Clothing material particles are retained by the various screen tiers, depending on mesh size, whereas the smaller or respectively also the dust-like contaminant particles can fall through. The retained clothing material particles are then set into motion through the brushes acting upon them and rub against each other so that additional contaminants are detached from their surfaces. These detached, generally comparatively smaller contaminants can then again pass through the screen openings. Contaminant particles fed into friction cleaning section 34 or respectively separation section 40 together with clothing material particles are separated immediately through the screen tiers from the clothing material particles. Contaminant material particles subsequently detached in the course of the friction cleaning process also move downward through the screen openings due to gravity and are thereby separated from the clothing material particles.

Based on the fact that, for example, clothing material particles in the previously stated size that is in a range of 1 cm to 3 cm fiber length are provided, the friction cleaning process can furthermore be performed very efficiently. The total surface over which the energy expanded for friction cleaning is distributed is clearly smaller than on even further comminution of paper machine clothing.

Subsequent to separation section 40 or respectively friction cleaning section 34 the particulate material taken from the various screen tiers and which essentially now only contains clothing material particles is subjected to a further cleaning process in after-cleaning unit 41 in order to remove final contaminations. Dry cleaning cylinder 42 can be used for this purpose. The clothing material particles emerging from it can then be fed to filling station 44, where they can be packaged, for example into bags, and can then be sent to further processing, for example pelletizing. It is also possible to provide a device in place of filling station 44 where the clothing material particles are processed further, for example where they are subjected to pelletization.

While this invention has been described with respect to at least one embodiment, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. A method for cleaning a structural material which is to be recycled and which is obtained from a papermachine clothing, the method comprising the steps of:
a) comminuting the papermachine clothing to form a plurality of clothing material particles and to detach a particulate contaminant material from at least one of the papermachine clothing and said plurality of clothing material particles;
b) separating said plurality of clothing material particles from said particulate contaminant material;
c) one of during and after said step b) detaching a contaminant material adhering to a surface of said plurality of clothing material particles from said step b) using friction cleaning; and
d) separating said plurality of clothing material particles from said contaminant material detached from said plurality of clothing material particles in said step c) at least one of during and after said step c).

2. The method according to claim 1, wherein the papermachine clothing is one of a forming fabric, a dryer fabric, a belt and a press felt.

3. The method according to claim 1, said step a) being performed using a cutting mill.

4. The method according to claim 1, during said step a) said plurality of clothing material particles of said step a) have a particle size in a range between approximately 2 to 30 millimeters (mm).

5. The method according to claim 4, said particle size being in a range between approximately 10 to 15 mm.

6. The method according to claim 1, said step b) including at least one of screening and sorting to separate said plurality of clothing material particles from said particulate contaminant material.

7. The method according to claim 6, wherein during said step c) said plurality of clothing material particles are caused to move against each other.

8. The method according to claim 7, said step c) further comprising the step of causing said plurality of clothing material particles to contact a plurality of extraction mediums.

9. The method according to claim 8, said step d) further comprising at least one of screening and sorting said plurality of clothing material particles and said contaminant material detached from said plurality of clothing material particles in said step c).

10. The method according to claim 9, during at least one of said step c) and said step d) said plurality of clothing material particles are kept at a predetermined temperature.

11. The method according to claim 10, said predetermined temperature being in a range between approximately 25 to 30° C.

12. The method according to claim 11, further comprising the steps of:
A) obtaining a plurality of substantially clean clothing material particles; and
B) pelletizing said plurality of substantially clean clothing material particles.

13. The method according to claim 12, further comprising the step of separating said plurality of substantially clean clothing material particles into a plurality of particle fractions dependent upon a plurality of different base materials of said plurality of substantially clean clothing material particles, said separation into said plurality of particle fractions being implemented after said step A) and prior to said step B).

14. The method according to claim 12, said step B) including an extrusion process.

15. The method according to claim 14, said extrusion process further including filtration of an extrusion material of said extrusion process.

16. A device for providing a structural material from a papermachine clothing which is to be recycled, the device comprising:
a comminution section for comminuting the papermachine clothing into a plurality of clothing material particles;
a friction cleaning section configured for detaching a contaminant material from said plurality of clothing material particles formed from the papermachine clothing; and
a separation section configured for separating said plurality of clothing material particles from said contaminant material detached in at least one of said comminution section and said friction cleaning section.

17. The device according to claim 16, said comminution section including a pre-comminution unit and a subsequent primary comminution unit.

18. The device according to claim 17, at least one of said pre-comminution unit includes a single shaft comminutor and said primary comminution unit includes a cutting mill.

19. The device according to claim 16, further comprising a pre-separation unit between said comminution section and said friction cleaning section, said pre-separation unit being configured for separating said plurality of clothing material particles from said contaminant material detached from said plurality of clothing material particles in said comminution section.

20. The device according to claim 19, said pre-separation unit including a gravity separator.

21. The device according to claim 16, wherein said friction cleaning section incorporates said separation section.

22. The device according to claim 21, said friction cleaning section including a screen unit.

23. The device according to claim 22, said screen unit being a tumbler screen having at least one screen tier.

24. The device according to claim 23, said tumbler screen having at least two screen tiers.

25. The device according to claim 23, further comprising a brush arrangement assigned to said at least one screen tier.

26. The device according to claim 16, said separation section following said friction section including an after-cleaning unit.

27. The device according to claim 26, said after-cleaning unit including a dry-cleaning cylinder.
